(19) United States
(12) Patent Application Publication
(10) Pub. No.: US 2019/0081813 A1
(43) Pub. Date: Mar. 14, 2019

(54) SYSTEM AND METHOD FOR MONITORING AND CONTROLLING DEVICES AND PROCESSES IN AN INFRASTRUCTURE

(71) Applicant: Agile Connects Pvt. Ltd., Maharashtra (IN)

(72) Inventors: Nitin Nistane, Maharashtra (IN); Arvind Khungar, Bangalore (IN); Anand Aurangabadkar, Maharashtra (IN)

(21) Appl. No.: 16/127,257

(22) Filed: Sep. 11, 2018

(30) Foreign Application Priority Data
Sep. 11, 2017 (IN) 201721032073

(51) Int. Cl. H04L 12/28; G05B 13/02; H04W 4/33; H04W 4/38

(52) U.S. Cl. CPC H04L 12/2816; G05B 13/024; H04W 4/38; H04W 4/33; H04L 12/2823

(57) ABSTRACT

Disclosed is a system and method for monitoring and controlling devices in an infrastructure. The system 100 and method 1100 comprise devices 105, 106, 107 and 108, wherein devices are continuously monitored and controlled based upon set points. Further comprises sensor 104 and switch 111 units comprising sensors and connectivity 102 and 109 with devices and a primary 103 or a central server 101. Primary servers 103 are configured to couple with central server 101, wherein a processor 209 in primary server 103 is configured to execute instructions stored in a memory coupled with primary server 103. The programmed instructions comprise instructions for receiving inputs from the sensors, wherein the sensors are configured to sense operating parameters of the devices and predefined parameters in the infrastructure. Further comprises processing, sensor inputs to determine events for monitoring and controlling the devices. The events comprise asset and energy management.

### CROSS-REFERENCE TO RELATED APPLICATIONS AND PRIORITY

The present application claims priority from Indian Application No. 201721032073 filed on 11^{th} Sep. 2017.

### TECHNICAL FIELD

The present subject matter described herein, in general, relates to a field of Internet of Things to monitor and control devices and processes. In particular, the present subject matter is related to a system and method for monitoring and controlling devices in an infrastructure for the purpose of energy saving, asset management, consumer behavior and Equipment as a Service.

### BACKGROUND

Now-a-days, people all over the world are becoming conscious towards saving of energy in general and electricity in particular. Currently, there are a variety of electronic and electrical gadgets and devices that are manufactured in such a way that they consume less electricity for working. These devices are also called as energy efficient devices. Although, people may have turned to usage of energy efficient devices, they tend to keep these devices ON even when not in use. People also tend to not use these devices at optimum operating points called Set Points. Hence, the energy saving devices do not give desired energy saving due to forgetfulness or laziness of people to switch off the devices when not in use or inappropriate set point parameters. Moreover, most of these energy efficient devices are so expensive that they do not offer economic benefit of savings Vs extra cost.

The proliferations of gadgets, equipment and machines all around us makes us depend on reliable functioning of the equipment. People (without violating the privacy regulations), machinery and processes are to be continuously monitored for health, operating parameters and energy efficiencies. The monitoring of machineries can be carried out via measurement of electrical, mechanical and visual profiles at various points of time to compare these parameters against defined parameters. Similarly, the quality of air within an infrastructure, including temperature and humidity, needs to be monitored and reported so that preventive action can be taken quickly to maintain and improve the air quality.

Individual users, be it corporate or single consumer, when install separate equipment usually there is over capacity of the installed base. This over capacity leads to higher cost of equipment, higher consumption of energy and also increased cost of maintenance. To install aggregate capacity of the consumer base in the society or building leads to optimum installed capacity and usage. To proportionately bill consumer as per usage is described as “Equipment as Service” or “Product as Service”.

People behavior in retail spaces becomes a very important parameter to measure for B2C businesses. Understanding consumer headcount, time spend pattern and linking this with their social network profile is a very effective way to propose to the consumer what she/he is looking for thereby increasing the chances of sale of merchandise to the consumer.

Therefore, there is a long-standing need of a system and method for monitoring and controlling devices and understanding consumer behavior in an infrastructure. Monitoring can be achieved by measuring the operating environment of the equipment, device or people. Controlling is achieved by calculating new operating parameters (or set points) by comparing measured operating environment and desired operating environment parameters.

### SUMMARY

This summary is provided to introduce concepts related to a system and method for monitoring and controlling devices in an infrastructure. This summary is not intended to identify essential features of the claimed subject matter nor is it intended for use in determining or limiting the scope of the claimed subject matter.

In accordance with the present subject matter a system for monitoring and controlling devices and processes in an infrastructure is illustrated. In one embodiment, the system comprises one or more devices in an infrastructure, wherein said devices are continuously monitored and controlled based upon one or more set points. Further comprises one or more sensor units and switch units comprising one or more sensors and a network connectivity with devices and a primary server or a central server. Further comprises one or more primary servers configured to communicatively coupled with a central server, wherein a processor in each primary server is configured to execute instructions stored in a memory coupled with each primary server for controlling and monitoring the devices. The programmed instructions comprise instructions for receiving, one or more inputs from the sensors in the sensor units or switch unit wherein the sensors in the sensor units or switch unit are configured to continuously sense the ambient and operating parameters of the devices one or more predefined parameters in the infrastructure. Further comprises processing, the one or more sensor inputs to determine one or more events indicative of monitoring and controlling the devices. The indicative events comprise asset management in the infrastructure, wherein asset management is configured to compare, alert and control the operating parameters of the devices. Further comprises energy management in the infrastructure, wherein energy management is configured to operate the devices as per one or more set points.

In one aspect, a method for monitoring and controlling devices and processes in an infrastructure is illustrated in accordance with the present subject matter. The method comprises establishing, via network connectivity one or more connections between central server, primary server, sensor units, switch units and devices. Further, comprises receiving, via a processor inputs from sensors in the sensor units or switch units, wherein the sensors in the sensor units or switch unit are configured to continuously sense the ambient and operating parameters of the devices and one or more predefined parameters in the infrastructure. Further comprises processing, via the processor one or more sensor inputs to determine one or more events indicating asset management and energy management for monitoring and controlling the devices. Further comprises processing, via the processor asset management in the infrastructure to compare, alert and control operating parameters of devices. Further comprises processing, via the processor energy management in the infrastructure to operate the devices as per one or more set points.

### BRIEF DESCRIPTION OF THE DRAWINGS

The detailed description is given with reference to the accompanying figures. In the figures, the left-most digit(s) of a reference number identifies the figure in which the reference number first appears. The same numbers are used throughout the drawings to refer like features and components.

FIG. 1 illustrates, a system 100 for monitoring and controlling devices 105, 106, 107 and 108 in an infrastructure. This is only a representative drawing and more such devices are added as product roadmap is under rapid evolvement.

FIG. 2 illustrates, an interfacing block diagram 200 of primary server 103.

FIG. 3 illustrates an interfacing block diagram 300 of sensor unit 104.

FIG. 4 illustrates an interfacing block diagram 400 of switch unit 111.

FIG. 5 illustrates, a set of dynamic instructions 500 for system 100.

FIG. 6 illustrates, a schedule zone and override instructions and interfacing hardware for schedule zone 600.

FIG. 7 illustrates, a motion zone categorized as presence or absence zone and motion schedule instructions 700.

FIG. 8 illustrates, overload preventive instructions 800.

FIG. 9 illustrates, an overall method 900 for controlling and monitoring the devices for the purpose of asset management.

FIG. 10 illustrates, an overall method 1000 for controlling and monitoring operating parameters of the devices in an infrastructure for the purpose of energy saving.

FIG. 11 illustrates a method 1100 for monitoring and controlling devices and processes in an infrastructure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

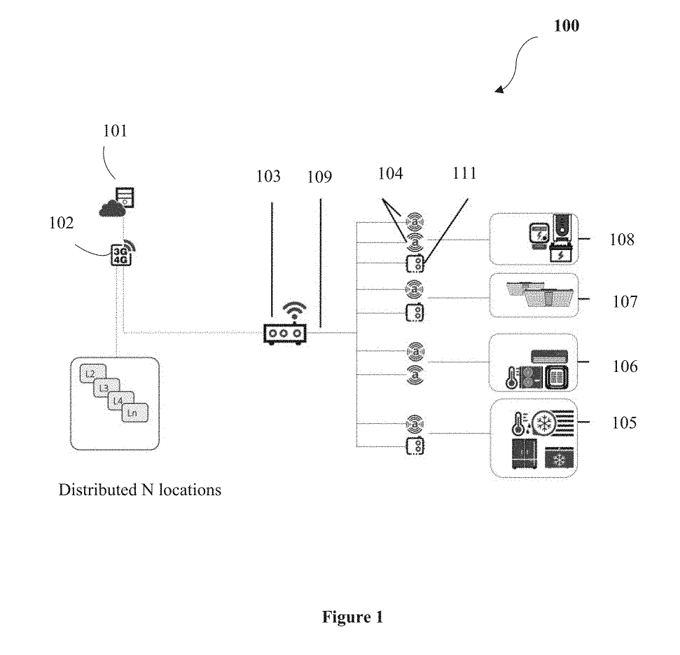

Referring now to FIG. 1, a system 100 for monitoring and controlling devices 105, 106, 107 and 108 in an infrastructure is illustrated in accordance with the present subject matter.

In one implementation, the system 100 may be accessed by a central server 101 and/or primary server 103. In one embodiment, the system 100 may be accessed by multiple users through one or more user devices (not shown in figure) or user, or applications residing on the user devices.

The system 100 may further accept information provided by user using the user devices, to register the respective user with the system 100.

In an embodiment, though the present subject matter is explained considering that the system 100 is accessed by a central server 101 and/or primary server 103, it may be understood that the system 100 may also be accessed by a variety of user devices, such as a but are not limited to, mobiles, a portable computer, a personal digital assistant, a handheld device, a laptop computer, a desktop computer, a notebook, a workstation, a mainframe computer, and the like.

In one implementation, the networks 102 and 109 enabling the system 100, may be a wireless network, a wired network, private network like LAN (Local Area Network) or VPN (Virtual Private Network) or public network like WAN (Wide area network) or GPRS or Internet or a combination thereof. The network of system 100 can be accessed by the central server 101 and/or primary server 103 using wired or wireless network connectivity means including updated communications technology.

In one embodiment, the system 100 may comprise a central server 101, an internet network 102, a primary server 103, sensor unit 104, switch unit 111, devices 105, 106, 107, 108. The network media 102, 109 to interconnect servers, sensors and devices can be wired or wireless or combination thereof.

The sensor unit 104 and/or switch unit 111 may comprise various sensors and gadgets such as temperature sensor, humidity sensor, lux sensor, motion sensor, camera, relay units, contactor units, communication devices comprising wireless (WiFi, Bluetooth), wired (RS485, Ethernet), IR transmitter and like sensors. The devices 105 may be powered devices comprising of refrigerators, deep refrigerators, walking refrigerators, ovens, coffee machines, geysers or similar devices. The devices 106 may be HVAC devices comprising HVAC appliances, duct able controllers, openable fresh air ducts or like devices. The devices 107 may be lighting devices comprising lighting appliances, LED drivers, street lighting or like devices.

In a preferred embodiment, the third-party devices 108 may comprise an energy meter, UPS, battery, solar panels, Gen Set, Air Quality Equipment, Elevators, Escalators or more other equipment.

In one embodiment, the internet network 102 may act as a connecting media between primary server 103 and central server 101. The network media 109 may act as a connectivity between primary server 103 and sensor units 104, switch unit 111 or devices 105, 106, 107, 108.

In one embodiment, switch unit 111 may be used for operating devices 105, 106, 107, 108.

In one embodiment, the sensor unit 104 and/or switch unit 111 may be used to activate relays to open or close fresh air ducts of HVAC system for the purpose of air side economizer or demand control ventilation function. Such system samples the air quality and compares it with the set threshold configured on the primary server 103. Instructions on primary server may activate the fresh air duct on detection of threshold breach, and wherein all such threshold breaches are reported to primary server 103 or central server 101 over network connectivity 102 or 108

In one embodiment, the sensor unit 104 and/or switch unit 111 may be used to measure electrical, mechanical and/or visual profiles of devices 105, 106, 107 and 108 and transmit the data sensed as a result to server 103 or 101 over network connectivity 102 or 108. The data received by server 103 or 101 may be further compared with ideal electrical, mechanical and/or visual profiles of devices 105, 106, 107 and 108. By doing so, the abnormalities, if any, in the profiles may be detected for further analysis and preventive actions like maintenance can be taken to enhance the useful life of the devices 105, 106, 107 and 108. During the analysis by central server 101 or primary server 103, the network connectivity 102 or 109 may be used to generate alerts and notifications for identified individuals.

In one embodiment, the central server 101 may be a cloud server. Although a preferred embodiment is mentioned, it may not be limited to said specifications. In one embodiment, the system 100 may comprise devices 105, 106, 107 and 108, wherein said devices 105, 106, 107 and 108 may be configured to work in an infrastructure such as offices, companies, houses, vehicles, public places like gardens, ground, streets, industries or like places. As the devices 105, 106 and 107 and 108 consume a large amount of electricity when turned on, these devices are required to be switched off when not in use or working intensity (Operating parameters or set points) of said devices may be adjusted instructively when usage or requirement of intensity is less. In one embodiment, said working intensity may be called as a set point, wherein said set point may be set as per the requirements. The system 100 may be configured to monitor and control the usage of said devices 105, 106, 107 and 108 in said infrastructures. The system 100 may comprise a sensor unit 104 or switch unit 111 configured to sense the usage of the devices 105, 106, 107 and 108 in a predefined infrastructure. The sensor unit 104 and/or switch unit 111 may comprise InfraRed Transmitter, Motion Sensor, Temperature and Humidity Sensor, Air Quality Sensor, Light Sensor, Headcount sensor, relays and contactors camera or like sensors and a network connectivity on wired or wireless media, comprising but not limited to RS485, sub gig wireless, WiFi, Ethernet, GPRS etc. The sensor unit 104 or switch unit 111 may communicate with devices 105, 106, 107 and 108 over wired or wireless media. The sensor unit 104 and/or switch unit 111 may be connected to the primary server 103 over wired or wireless media. The sensor unit 104 and/or switch unit 111 may be connected to the central server 101 over wired or wireless media. The sensor unit 104 and/or switch unit 111 comprise of microcontroller based custom developed hardware, connecting interfaces and firmware. The sensor unit 104 and/or switch unit 111 offer industry standard interfaces and protocols. The sensor unit 104 and/or switch unit 111 may offer custom developed interfaces and protocols.

Further, the system 100 comprises a primary server 103, wherein said primary server 103 may be an appliance with standard and custom developed hardware, network interfaces, embedded with an operating system and custom developed software and firmware implemented platform. The primary server 103 may have connectivity with the central server 101 via internet network, cloud platform, GPRS platform or other such like platforms. The primary server 103 may be configured to schedule parameters for monitoring and controlling devices 105, 106, 107 and 108 in the infrastructure. In one embodiment, the primary server 103 may receive sensor inputs from sensor unit 104 and/or switch unit 111 and third-party sensors in 108. In one embodiment, the third-party devices 108 may comprise of third party sensors like temperature and humidity, flow, pressure, air quality, smart energy meters, special cameras and likes that have standard communication interfaces like RS485 ModBus, Ethernet or Bluetooth and likes in order to connect with primary server 103 over standard connectivity 109. Primary server 103 may be programmed to receive inputs from such third-party sensors over connectivity 109 and take decision to send activation commands to command and control devices 105, 106, 107 and 108. The primary server 103 may also receive inputs from other sources like central server 101, Google Weather or similar or internal algorithmic programs. Depending upon the inputs received, the primary server 103 may be configured to schedule predefined parameters, called set points, and further transmit said set points to control devices 105, 106, 107 and 108.

The sensor unit 104 and/or switch unit 111 may constantly monitor the working of the devices 105, 106, 107 and 108 and provide the monitored or sensed inputs to the primary server 103 over the network 109, wherein the network 109 may be wireless or wired. Further, the system 100 may comprise a central server 101, connected with one or more primary server 103 via GPRS, leased line, broadband, VPN internet network 102 or like services. The central server 101 may be embedded with a cloud hosted computer implemented custom developed and third-party software applications, wherein multiple primary servers 103 may be controlled and monitored by said central server 101. The central server 101 may also receive inputs from sources like primary server 103, Google Weather or similar or internal algorithmic programs. The central server 101 may be configured to perform data analytics for monitoring and controlling one or more primary server 103. The central server 101 may also be configured to decide the instructions, for working of the system 100. The central server 101 may also connect to third party analytics and security applications like IBM Watson or similar communicating over internet network 102 using standard APIs (Application Programming Interfaces).

Basically, the central server 101 may enable monitoring and controlling of sensor unit 104 and/or switch unit 111, devices 105, 106, 107 and 108 by a central configuration.

In one embodiment, the sensor unit 104 and/or switch unit 111 may send schedule commands received from central server 101 or primary server 103 to devices 105, 106, 107 or 108 at predefined time period to bring the device back to its schedule even though a deviation is caused in the desired set point for operating the devices 105, 106, 107 or 108.

In one embodiment, the system 100 may comprise plurality of primary servers 103. In absence of primary server 103, central server 101 may act as the server of the system 100.

In one embodiment, the system 100 may be used in an infrastructure comprising of a single or multiple building having multiple tenants, who are provided some common services like HVAC or Water, which are created centrally for the infrastructure and are provided to tenants with some controls for them to turn on/off HVAC (or water) within their area and the system 100 may be used to derive the exact quantum of cool air or water supplied to each of these tenants. Such quantum may be calculated using the measurement data generated from devices 105, 107, 107 or 108 and strategically placed sensor units 104 and/or switch unit 111 in the said infrastructure at various locations, such that the extent of cooling within the sub-area of the tenant is calculated and linked to the electricity consumed for that cooling and by extrapolating similar calculations, the total cost of electricity for the infrastructure is divided among the tenants so as to provide “product as a service” rather than calculating such share of cost based on area occupied by the tenant. By doing so, the tenant using higher quantum of cool air would be charged more as compared to a tenant using lower quantum of cool air—though both the tenants may occupy same size of area within the infrastructure. The system 100 comprises a product as service in the infrastructure, wherein operating hours and parameters of devices in 105, 106, 107, 108 are consolidated for fair distribution of Energy Expense per usage of consolidated capacities.

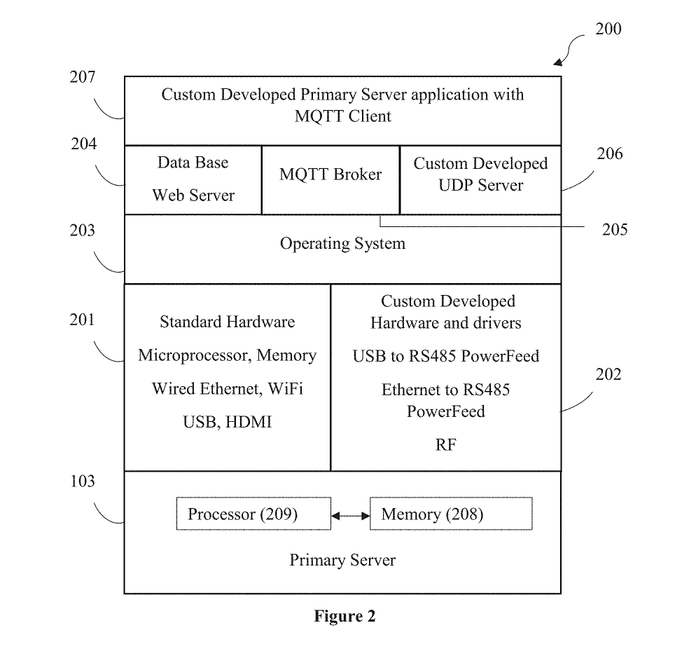

Referring now to FIG. 2, an interfacing block diagram 200 of primary server 103 is illustrated in accordance with the present subject matter. In one embodiment, the primary server 103 may communicate with sensor unit 104 and/or switch unit 111 and devices 105, 106, 107 and 108. Said communication may be done over wired or wireless network media 109. Similarly, primary server 103 may communicate with central server 101 over wired or wireless media using internet network 102 technologies. In one embodiment, the primary server 103 may comprise of standard hardware 201 wherein said standard hardware 201 may comprise microprocessor, memory, wired ethernet, wi-fi USB, HDMI or like hardware. Further, the primary server 103 may comprise, a custom developed hardware and drivers 202 wherein this own developed hardware and drivers can connect primary server to own developed sensor unit 104 and/or switch unit 111 and devices in 105, 106, 107 and 108. Further, there may be standard set of programs called operating system 203, database and web server 204 and communication protocol called MQTT (Message Queue Telemetry Transport) 205. Said standard programs 203, 204 and 205 may interface with the standard hardware 201 of primary server 103. Further, the developed hardware 202 may interface with developed computer implemented platform called drivers and communication engine called User Datagram Protocol (UDP) server 206. The primary server 103 may store configuration parameters, schedules, energy usage data, temperature data, other sensor data in a memory 208 comprised in the primary server 103. The primary server 103 may comprise a processor 209 configured to take control decisions based on the custom-built computer implemented platform and may communicate with the sensor unit 104 and/or switch unit 111 and devices 105, 106, 107 and 108. The primary server 103 may also receive inputs from central server 101 and may periodically send data to central server 101 over internet network 102. Computer implemented platform of primary server application with MQTT client 207 may be accessed by the user. Said MQTT client 207 enables communication of the primary server application with other MQTT enabled central server, custom developed sensor unit 104 and/or switch unit 111 and devices 105, 106, 107 and 108. This communication may be routed through MQTT Broker 205.

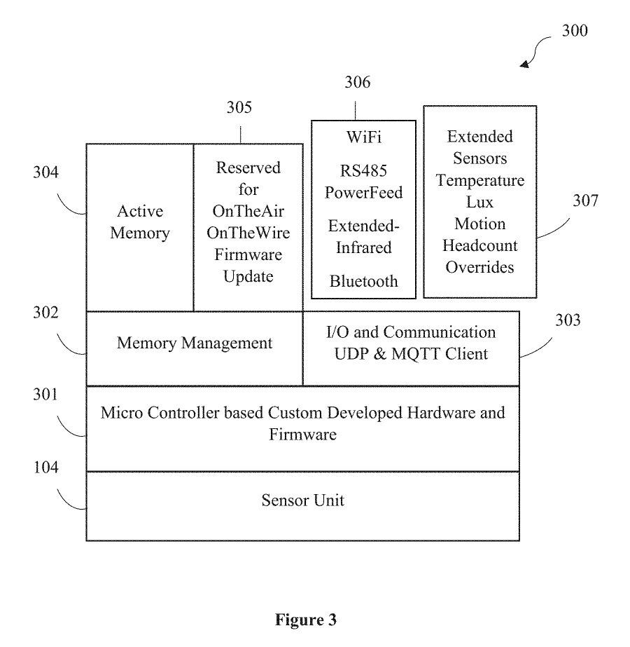

Referring now to FIG. 3, an interfacing block diagram 300 of sensor unit 104 is illustrated in accordance with the present subject matter. In one embodiment, the sensor unit 104 may be micro-controller based custom developed hardware and firmware. The sensor unit 104 may comprise a memory management module 302. Said module 302 may manage the presently used active memory 304 for the operations of the sensor unit 104. The memory management module 302 may also manage another part of the memory that may be used for firmware update through OTA or OTW (OnTheAir or OnTheWire) 305 mechanism. OTA or OTW 305 may allow the sensor unit 104 to receive any update to its firmware from the primary server 103 or central server 101 over network connectivity 102 and 109 without disruption to the sensor unit 104 running operations. The received update may be checked for the sanity and authenticity. Once all the checks are passed on the received new firmware, sensor unit 104 may discard the present firmware and shift operations to new firmware. Said mechanism of OTA or OTW 305 may allow broadcasting the firmware to many sensors units 104 in the field from central location without physically visiting the location of sensor unit 104. Said custom developed feature may give sensor unit 104 unique ability to receive updates from the central server 101 or primary server 103. The memory management module 302 may ensure that the update received is authentic and faithful. In case of any failure of faithful reception of the firmware update 305, the memory module 302 may continue operations from the active memory region 304, without any disruption to normal operations of the sensor unit 104. Further, other module of the sensor unit 104 may be I/O and Communication module 303. The communication with primary server 103 over wired or wireless media may be handled by said communication module 303. Communication with devices in 106 and 107 may also be handled by the communication module 303. The communication module 303 may comprise of custom developed communication firmware, UDP Client and standard communication protocol called MQTT client. Interfacing with sensors and relays may be done through I/O and communication module 303.

In one embodiment, the processor 209 of the primary server 103 may be coupled with the memory 208, wherein the memory 208 may be fed with executable instructions and the processor 209 may be configured to execute the stored instructions. In one embodiment, the executable instructions may comprise instructions of a head count and movement heat map, dynamic instructions 500, schedule zone, motion schedule instructions 700, overload preventive instructions 800, and override instructions described in the description further. In one embodiment, the sensor unit 104 may comprise of various sensors 307 such as temperature, lux or light, motion headcount, air quality and like sensors. In one embodiment, a motion sensor may be configured to detect a motion in the infrastructure premises. In one embodiment, the motion may be predefined. Further, the air quality sensor may be configured to sense the ambient air quality in the infrastructure. The light sensor may be configured to sense the intensity of light in the infrastructure. The headcount sensor may be configured to count the number of people in the infrastructure. The temperature sensor may be configured to sense the ambient temperature in the infrastructure. In one embodiment, the sensor unit 104 may further comprise Wi-Fi connecting devices 306 such as may be mobiles or any such portable devices. Tracking WiFi end points like mobiles may enable the working of a head count and movement heat map instructions, wherein said instructions may be configured to give a count of total number of people present in the premises of the infrastructure. Mobile identity management may enable linking of social media profiles and activities to the people present in the premise.

In one embodiment, the sensor unit 104 may comprise IR transmitter wherein, said IR transmitter may be configured to transmit IR signals to one or more IR receiving devices 106 and 107. In one embodiment, the sensor unit 104 may comprise a camera, wherein the camera may be configured to capture the profile of the people in the infrastructure and enable comparing of the captured profile with the prestored profile data in the memory 208 of the primary server 103.

In one embodiment, the sensor unit 104 may further comprise a network connectivity on wired or wireless media, comprising RS485, sub gig wireless, WiFi, GPRS etc. further embedded with a computer implemented platform. Said network connectivity and embedded computer implemented platform may be configured to enable connectivity between the sensor unit 104, the primary server 103 or central server 101, and the devices 106 and 107. The wireless network of the sensor unit 104 may form a meshing topography, meaning sensor unit 104 may reach the destination via multiple possible converging routes. In said topology every sensor unit 104 may act as a router and node both. The system 100 may comprise of plurality of sensor unit 104.

Sensor Unit 104 may have extended mounting of sensors 307 and communication hardware 306. Said extended and goose neck featured conduit from the sensor unit 104 enclosure to 307 and 306 may allow maximum network strength connectivity, reliable communication with devices in 106 and 107 in difficult trans-receiver angles and distributed and most appropriate placement of the sensor 307.

Sensor Unit 104 may have an override button to operate the connected device devices 106 and 107 out of schedule.

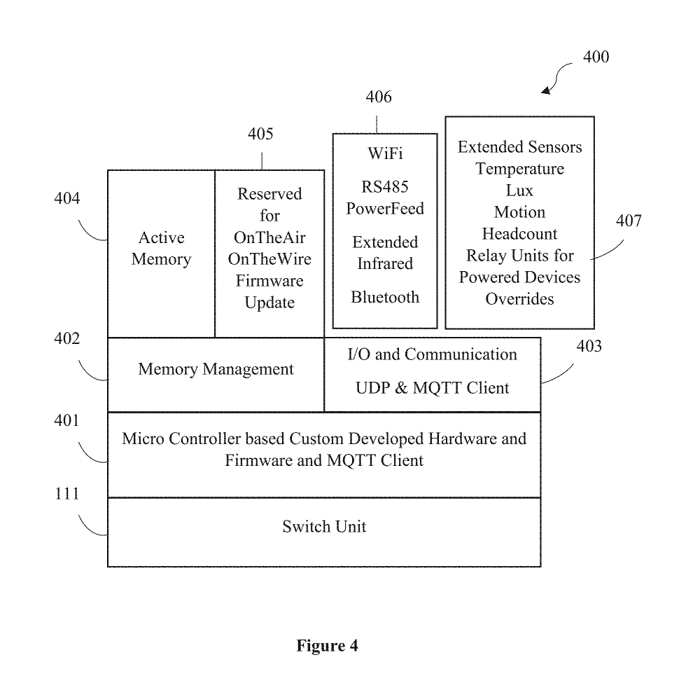

Referring now to FIG. 4, an interfacing block diagram 400 of switch unit 111 is illustrated in accordance with the present subject matter. In one embodiment, the switch unit 111 may be micro-controller based custom developed hardware and firmware. The switch unit 111 may comprise a memory management module 402. Said module 402 may manage the presently used active memory 404 for the operations of the switch unit 111. The memory management module 402 may also manage another part of the memory that may be used for firmware update through OTA or OTW (OnTheAir or OnTheWire)305 mechanism. OTA or OTW 305 may allow the switch unit 111 to receive any update to its firmware from primary server 103 or central server 101 over network connectivity 102 and 109 without disruption to its present operations. The received update is checked for the sanity and authenticity. After all the checks are passed on this received new firmware, switch unit 111 discards the present firmware and shifts operations to new firmware. This mechanism of OTA or OTW 305 may allow broadcasting the firmware to many switch units 111 in the field from central location without physically visiting the location of switch unit 111. The custom developed feature may give switch unit 111 unique ability to receive updates from the central server 101 or primary server 103. The memory management module 402 may ensure that the update received is authentic and faithful. In case of any failure of faithful reception of the firmware update 405, the memory module 402 may continue operations from the active memory region 404, without any disruption to normal operations of the switch unit 111. Further, other module of the switch unit 111 may be I/O and Communication module 403. The communication with primary server 103 over wired or wireless media may be handled by said communication module 403. Communication with devices in 105, 106 and 107 may also be handled by the communication module 403. The communication module 403 may comprise of custom developed communication firmware, UDP Client and standard communication protocol called MQTT client. Interfacing with sensors and relays may be done through I/O and communication module 403. In one embodiment, the switch unit may comprise of various sensors 407 such as temperature, lux or light, motion headcount, air quality and like sensors. In one embodiment, a motion sensor may be configured to detect a motion in the infrastructure premises. In one embodiment, the motion may be predefined. Further, the air quality sensor may be configured to sense the ambient air quality in the infrastructure. The light sensor may be configured to sense the intensity of light in the infrastructure. The headcount sensor may be configured to count the number of people in the infrastructure. The temperature sensor may be configured to sense the ambient temperature in the infrastructure. In one embodiment, the switch unit 111 may have multiple relays connected on the I/O pins of the microcontroller. These relays are electrically connected to devices in 105 for controlling the operation. In one embodiment, the switch unit 111 may further comprise Wi-Fi connecting devices 406 such as may be mobiles or any such portable devices. Tracking WiFi end points like mobiles may enable the working of a head count and movement heat map instructions, wherein said instructions may be configured to give a count of total number of people present in the premises of the infrastructure. Mobile identity management may enable linking of social media profiles and activities to the people present in the premise.

In one embodiment, the switch unit 111 may comprise IR transmitter wherein, said IR transmitter may be configured to transmit IR signals to one or more IR receiving devices 106 and 107. In one embodiment, the switch unit 111 may comprise a camera, wherein the camera may be configured to capture the profile of the people in the infrastructure and enable comparing of the captured profile with the prestored profile data in the memory 208 of the primary server 103.

In one embodiment, the switch unit 111 may further comprise a network connectivity on wired or wireless media, comprising RS485, sub gig wireless, WiFi, GPRS etc. further embedded with a computer implemented platform. Said network connectivity and embedded computer implemented platform may be configured to enable connectivity between the switch unit 111, the primary server 103 or central server 101, and the devices 105, 106 and 107. The wireless network of the switch unit 111 may form a meshing topography, meaning switch unit 111 may reach the destination via multiple possible converging routes. In said topology switch unit 111 may act as a router and node both. The system 100 may comprise of plurality of switch unit 111.

Switch unit 111 may have extended mounting of sensors 407 and communication hardware 406. This extended and goose neck featured conduit from the switch unit 111 enclosure to 407 and 406 allows for maximum network strength connectivity, reliable communication with devices in 105, 106 and 107 in difficult trans-receiver angles and distributed and appropriate placement of the sensor 407.

Switch Unit 111 may have override button to operate the connected device 105, 106 and 107 out of schedule.

In one embodiment, the sensor unit 104 and/or switch unit 111 comprises the override button to switch devices 105, 106, 107, 108 out of schedules, wherein the override button enables the sensor unit 104 to switch devices 105, 106, 107, 108 ON or OFF out of schedule. Such out of schedule overrides may also be reported to primary server 103 or central server 101 over network connectivity 102 or 109.

In one embodiment, the primary server 103 is such that it has sufficient processing power, main memory and storage enabling the primary server 103 to continue to command and control the system in the event of network connectivity failure causing disconnectivity with the central server. After restoration of the network connectivity, an accumulated data processed during network connectivity failure by the primary server to control and command the system 100 is uploaded to the central server 101 and further any new global policies generated during network connectivity failure are downloaded from the central server 101.

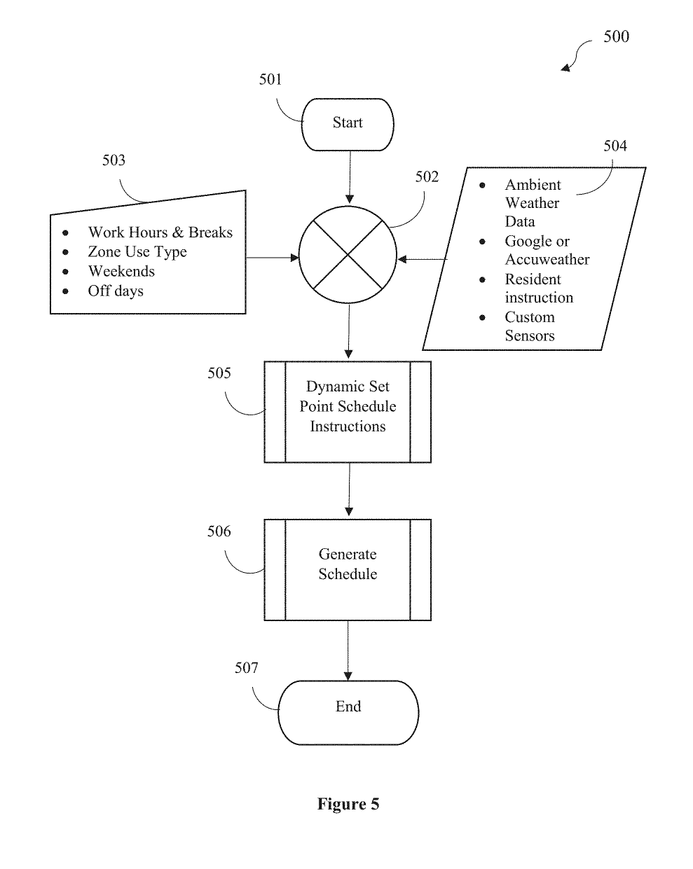

Referring now to FIG. 5, a set of dynamic instructions 500 for system 100 is illustrated in accordance with the present subject matter. In one embodiment, the dynamic instructions 500 may be configured to control and monitor the devices 105, 106, 107 and 108 as per the requirement and usage. The instructions 500 involves setting a set point. At step 501, the dynamic instructions may be started and may continuously work in loop. In a preferred embodiment, at step 503, considering an office infrastructure, defining of various parameters may be conducted. Said parameters may comprise number of working week days, working and non-working weekends, holidays, working half days, office timings for weekdays, weekends, half days, type of office spaces such as cabin, conference room, work area or like spaces, type of zones applicable for the type of office such as motion zone or schedule zone (motion zone and schedule zone are defined in the later part of the specification). At step 504, ambient weather data may be obtained by means of sensors in the sensor unit 104 or switch unit 111 or Internet implemented platforms such as Google or Accuweather. At step 502, processing and comparing of the data of step 503 and 504 may be conducted by the primary server 103, in order to obtain desired operating parameters, wherein these parameters may be called as set points. The set points may comprise but not limited to the required room temperature, speed of fan, swing of air conditioners or like parameters at different type of office space, at different timings of the day. At step 505, appropriate set point may be set by issuing set point commands based on the type of office space, time of the day, season of the year and the other defined parameters. At step 506, with a frequency of 15 minutes or 30 minutes or any other predefined duration, said appropriate set point commands may be re-generated by the primary server 103 based on the defined parameters. Said step may be performed in order to monitor or newly set a set point as per requirements. At step 507, the process may be ended after day-end status for devices 105, 106, 107 and 108.

In a preferred embodiment, an office infrastructure, there are various workspaces like personal cubical, conference rooms, cabins, canteen and like spaces. A set of dynamic instructions 500 may be executed in said infrastructure in order to set the operating set points for the devices 105, 106, 107 and 108. The room temperature, light intensity and such predefined parameters may be adjusted depending on the outside or surrounding parameter recordings. Said adjustment and processing may be performed by the processor 209 of the primary server 103. The overall ambient room conditions in the office may be adjusted according to the calculated set points. Here, without manual interference, the managing of the room conditions may be performed. One may not have to constantly adjust the working of the devices 105, 106, 107 and 108, instead automatically the infrastructure ambient conditions may be managed as per the set points. The set points may also be revised based on outside weather conditions or inputs received from sensors and Internet platforms like Google Weather or any resident instructions etc. The devices 105, 106, 107, 108 may be configured to work as per the set points.

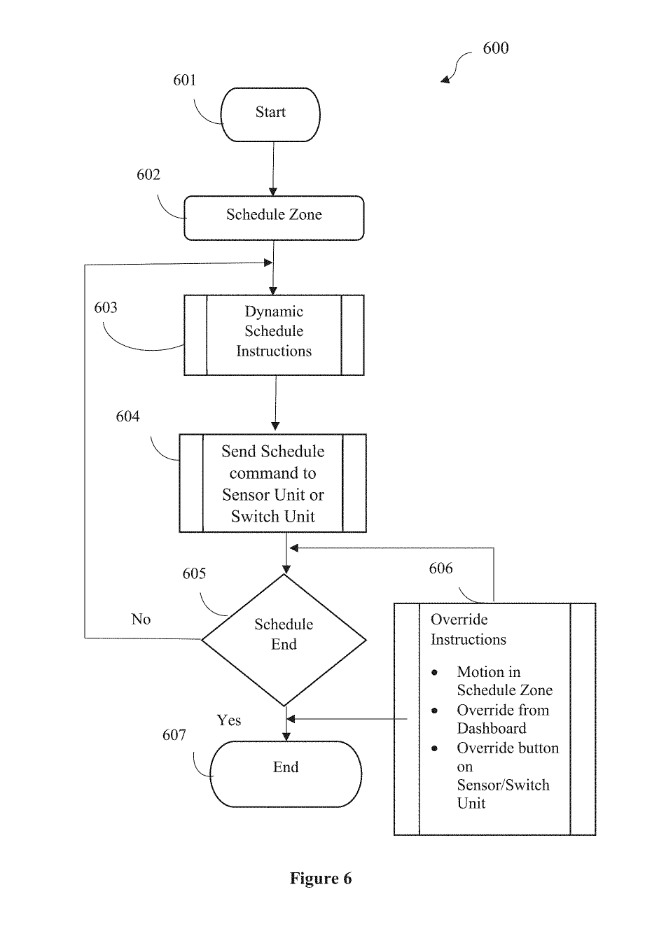

Referring now to FIG. 6, a schedule zone and override instructions and interfacing hardware for schedule zone 600 is illustrated in accordance with the present subject matter. Step 601 indicates the start of the instructions 600. At step 602, a schedule zone in the infrastructure may be defined. The schedule zone may be defined as per the type of infrastructure. At step 603, the dynamic instructions 500 may be executed. At step 604, schedule command may be sent to sensor unit 104 or switch unit 111. The schedule command may be decided and may be in relevance with the defined schedule zone. At step 605, a decision of ending of the schedule instructions 600 may be taken. In case the decision may be negative, the instructions 600 may be repeated from step 603. In case the decision is positive, at step 605, the process may be ended after day end status for the devices 105, 106, 107 and 108.

If the decision to end schedule at 605 is positive, and there is need for switching on the devices in 105, 106, 107, 108, then an override instructions comprising detection of any motion of human in the schedule zone may be executed at step 606. Further, if there may be no motion sensor in the schedule zone and still there may be need switch on the devices in 105, 106, 107, 108 when the generate schedule command decision is negative, an override may be provided on the dashboard of primary server 103 or hardware of sensor unit 104 or switch unit 111, which will switch on the devices in 105, 106, 107, 108 for predefined period of time.

In a preferred embodiment, the instructions 600 may be executed by the processor 209 of the primary server 103.

Typically, in automation deployment, large work areas and open work areas are defined as schedule zones. Preferably, the air conditioning system and lighting systems and other powered devices may be operated at predefined time schedules in the schedule zones. The instructions 600 may be configured to work when the time schedule ends and handles deviations of switched off air conditioning system, lighting system and other powered devices on termination of schedule zone, even when there may be desired motion in the infrastructure. Such handling may be seamless and in an automated manner.

In one embodiment, the instructions 600 may work in a predefined manner until a scheduled time of the office. Further, if the sensor unit 104 or switch unit 111 may detect presence of desired motion in the office after end of schedule time, then the processor 209 of the primary server 103 may switch on or keep on, the devices 105, 106, 107 and 108 until the desired presence may be detected. Also, the set points may be regenerated as per requirements. Even though preferred embodiments are mentioned, the specification may not be limited to said preferred embodiments.

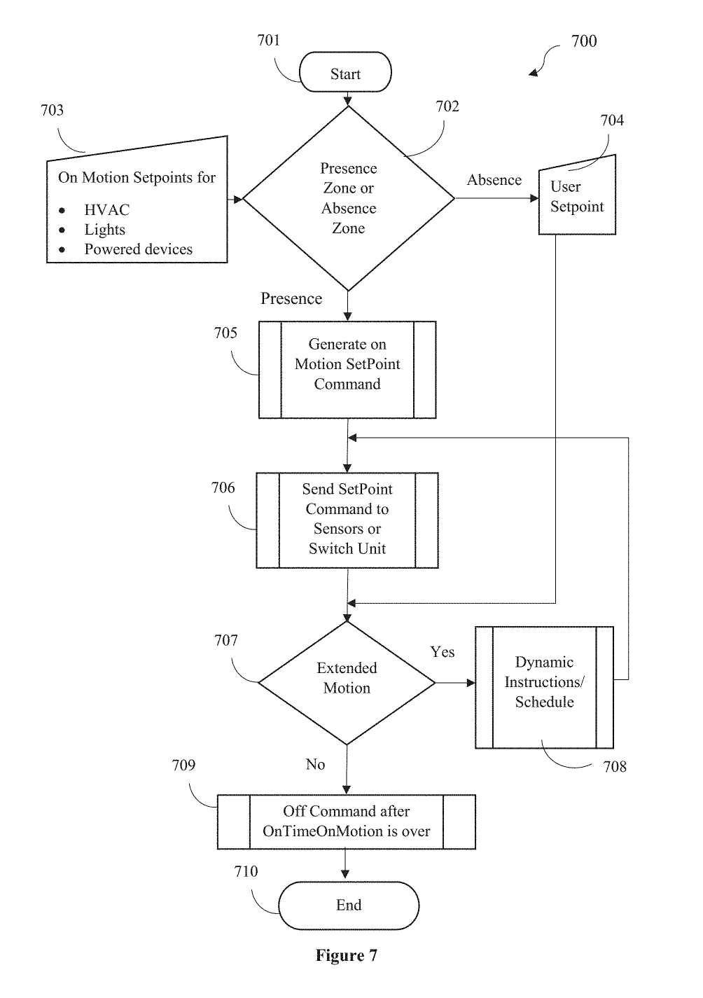

Referring now to FIG. 7, a motion zone categorized as presence or absence zone and motion schedule instructions 700 is illustrated in accordance with the present subject matter. Step 701 indicates the start of the instructions 700. At step 703, defining of a motion zone with motion parameters may be conducted, wherein motion parameters may be predefined for fixed time interval. The motion parameters may comprise but not limited to On Time, temperature, fan speed, lux level, etc. Further, at step 702, presence zone or absence zone of desired motion may be defined. In case, of absence zone, the set point may be set at step 704 as per the above defined instructions, and in the further step at 707 a desired extended motion may be verified. In case of presence zone, at step 702, an on-motion set point command may be generated at step 705. Further, the set point command may be sent to the sensors in the sensor unit 104 or switch unit 111 at step 706. Further, at step 707, the extended motion may be verified. In case, if the extended desired motion may be detected in the motion zone at step 707, then the dynamic instructions 500 may be configured and executed at step 708. After step 708, the steps from 706 may be executed in a loop until the condition is satisfied. In case, no such extended motion is detected at step 707, the process may be ended after motion off status of all the devices 105, 106, 107 and 108 at step 709. In a preferred embodiment, the schedule in motion zone instructions 700 may be executed with regard to detected presence or absence zone. Initially the on-motion parameters of the devices 105, 106, 107 and 108 may be defined. Said parameters may comprise, On Time, temperature, fan speed, mode, swing, lux level of devices 105, 106, 107 and 108 or like parameters. Further, a presence or absence zone may be detected. In case the absence zone is detected, then the set point may be set accordingly.

In one embodiment, passive infrared motion detectors but may not be limited to said detectors, may indicate the presence of motion of a person in the infrastructure, wherein the detectors may detect the change in infrared as every person has a tendency of naturally emitting some infrared radiations. In one embodiment, the sensor unit 104 and switch unit 111 comprises motion detector for reporting motion and energy use out of schedule wherein such out of schedule motion and energy use are also reported to primary server 103 or central server 101 over network connectivity 102 or 109.

Said sensors may be routinely used in executive offices, conference rooms, wash rooms and like places. The absence zone may be defined as a zone wherein the desired motion is detected but no action is taken. For example, in an executive office, the time duration wherein the house-keeping may perform their chores, there is no need of automatic turning on of devices 105, 106, 107 and 108. Absence zone prevents such false motion that could trigger the devices 105, 106, 107 and 108 ON. Hence in an absence zone, devices 105, 106, 107 and 108 are not commanded to ON status on Motion Detection. In absence zone devices 105, 106, 107 and 108 may be switched on as per requirement. But in this scenario, there may be a need of switching off the devices 105, 106, 107 and 108, which may be left in ON state unintentionally. Hence executing the absence zone wherein no action is taken by the system 100 and user is given the choice to activate the devices 105, 106, 107, 108 according to the set points of choice, and wherein the devices 105, 106, 107, 108 are switched off by system 100 on detection of absence of people in order to avoid false triggering of devices 105, 106, 107, 108 due to unintended motion or presence. In one embodiment, the all the sensors in the sensor unit 104 and/or switch unit 111 may contribute in detection of presence or absence of desired motion in the infrastructure. In case of detection of such absence zone, the set point may be set by the user. Further, continued presence may be verified and under such condition dynamic instructions 500 may be executed. Said working of the absence zone may continue until the presence condition false may be detected and further the process may be ended. In case of presence zone, wherein the presence zone may be a defined as presence of desired motion according to scheduled time duration, working of devices 105, 106, 107 and 108 may be set as per the set point parameters defined on sensor unit 104 or switch unit 111, wherein set point parameters on motion may comprise On Time, temperature, fan speed, mode, swing, lux level or like parameters of devices 105, 106, 107, 108. On detection of such presence zone, an on-motion set point command may be generated, wherein such command may be configured to set a set point in on motion state. Further, the set point command may be sent to the sensors as per the previous defined instructions. In the presence zone, on detection of every desired motion in the infrastructure, the devices 105, 106, 107 and 108 are turned on. Hence, a predefined-on time on motion may be stated for working of devices 105, 106, 107 and 108 in the presence zone. In case a desired extended motion, the instructions 500 may be used in order to operate on dynamic set points rather than static on motion parameters. The instructions are executed via processor 209 of the primary server 103. The devices 105, 106, 107 and 108 may be turned on or off as per the commands sent to the actuator of the devices 105, 106, 107 and 108. The devices 105, 106, 107 and 108 may work as per the customized set points and detected zones.

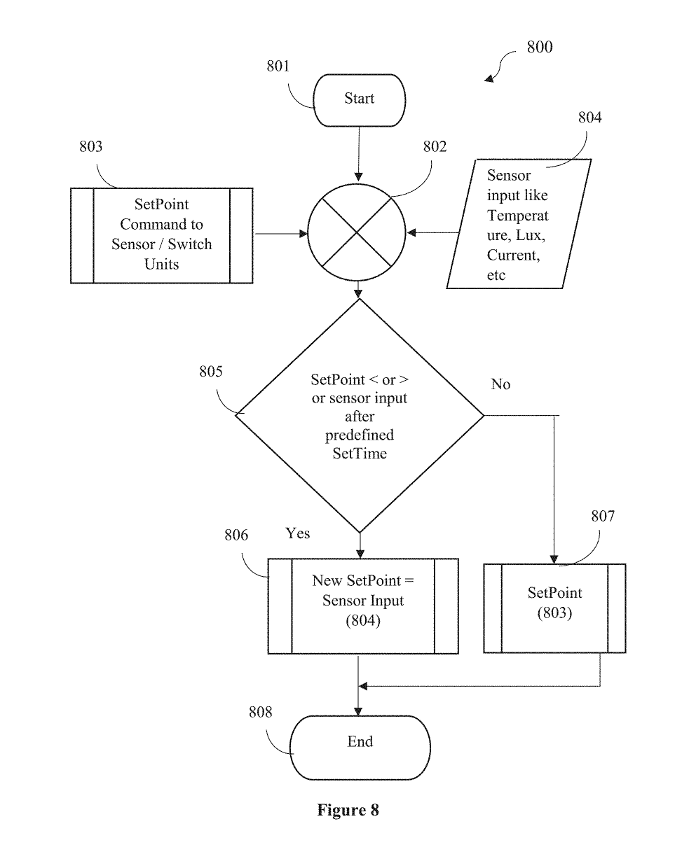

Referring now to FIG. 8, overload preventive instructions 800 is illustrated in accordance with the present subject matter. Said instructions 800 prevents the devices 105, 106, 107 and 108 from being overloaded than their maximum or minimum limits. Step 801 indicates the start of the instructions 800. At step 803, the set point command to the sensors in the sensor unit 104 or switch unit 111 may be initiated. At step 804, sensor inputs such as temperature, lux, current, etc may be obtained from the sensors in the sensor unit 104, switch unit 111 or devices in 105, 106, 107 or 108. At step 802, the processing of the inputs obtained from step 803 and step 804 may be performed via processor 209. Further, at step 805, acknowledging of the required set time may be verified. In case, the predefined set point may not be reached in the required set time, then a new set point may be configured for further efficient working of the devices 105, 106, 107 and 108 at step 806. In case, the set point may be reached in the required set time, then the acquired set point may be tallied with the initiated predefined set point at step 807. Further, at step 808, the process may be ended after turning off all the devices 105, 106, 107 and 108.

Considering an infrastructure of an office, a schedule zone of said infrastructure may be defined. The schedule zone may be configured as per the working hours of the office, wherein the working hours may resemble presence of people working in the premises. Further, the dynamic schedule instructions 500 may be executed. In a preferred embodiment, an air conditioner may cool the office to a level of the set point. When the temperature reaches the set point, the compressor of the air conditioner either may switch off or may be modulated to lower the cooling. Due to the said working of the compressor, lowered cooling temperature may be set to rise again. The thermostat in the indoor unit of the air conditioner may compare the rising temperature with the set point. Once, the rising temperature may cross a dead band which may be usually 2 degrees Celsius above the set point, the air conditioning system may increase the cooling either by starting the compressor or modulating the compressor to deliver more cooling. Usually, the air conditioning systems are designed for such cyclic operations, but because some equipment may be under-capacitated or may not be in proper working position, or the user has set the temperature to far too low value, the temperature in the infrastructure does not reach the set point. Hence, may lead to compressor being continuously switched on resulting in excessive energy consumption without impact on cooling and reduced life of the equipment.

On the contrary, the processor 209 of the primary server 103 of system 100 is configured to set a new set point. The instructions 800 may compare the infrastructure temperature in the office with the set temperature after predefined duration of time. In case, the infrastructure temperature is consistently more than the set temperature, then to avoid excessive energy spend and un-warranted wear and tear of the air conditioning equipment, the processor 209 may set a new set point which may be equal to the lowest reached temperature in the infrastructure. In one embodiment, the security features of the system 100 may be designed in such a manner that all the individual end points, sensor unit 104, switch unit 111, primary server 103 installed at different locations across may be provided with updates through Internet/VPN connectivity by self-learning process, using either OTA or OTW 305 update mechanism (OnTheAir or OnTheWire). Hence personal and physical intervention for updating the firmware or the software may not be needed. There is better efficiency in implementation of updates and least human intervention for making the system 100 update operational. Secondly, there is no change being carried out in the existing infrastructure or embedding of devices 105, 106, 107 and 108. Such updates may be verified for validity, authenticity and faithfulness. If any of these check fail, the update is rejected. During the process of OTA or OTW 305 the normal working operations of system 100 may not be impacted.

In case of any discrepancy in working of the system 100, the device 105, 106, 107 and 108 functioning may be impacted. Therefore, in such a situation, only the working of the primary server 103 may be switched off. The system thus provides better security and fall back over any potential problem after implementation of the system 100. This is possible as the system 100 is non-intrusive and non-disruptive, which means the system 100 does not alter the electric circuitry of devices 105, 106, 107 and 108 hence it if operationally very easy to connect or disconnect system 100 from devices 105, 106, 107 and 108. In one embodiment, the sensor unit 104 and/or switch unit 111 may be configured to capture error codes and operating status from devices 105, 106, 107 and 108. The sensor unit 104 and/or switch unit 111 may monitor operating mechanical and electrical parameters related to high and low pressure of refrigerant or any other liquid or gas, vibrations, temperature, humidity, air quality, flow rate, current, voltage, power factor, load factor, active power, reactive power, time of the day, frequency, phase reversal, single phasing of the devices 105, 106, 107 and 108. The analysis of these captured parameters and benchmark or reference operating parameters may give the system 100 ability to forecast any equipment failure. Said feature may be called as Asset Management. Said asset management may be enabled via wired or wireless network and computer implemented platform.

In one embodiment, the system 100 may deliver equipment functionality to multi-tenanted cluster of users enabling optimum usage of installed capacity which may be called as Equipment as service.

In one embodiment, the central server 101 may be configured to receive and transmit signals to one or more primary server 103 via network connectivity 102. In one embodiment, the head count sensor, motion sensor, wi-fi connecting device in the sensor unit 104 and/or switch unit 111 may be used to spot number of headcount in a given space by determining presence of Wi-Fi end points. Multiple sensors in the sensor unit 104 combines to form a movement detection heat map fabric which may plot the people movement inside a given space.

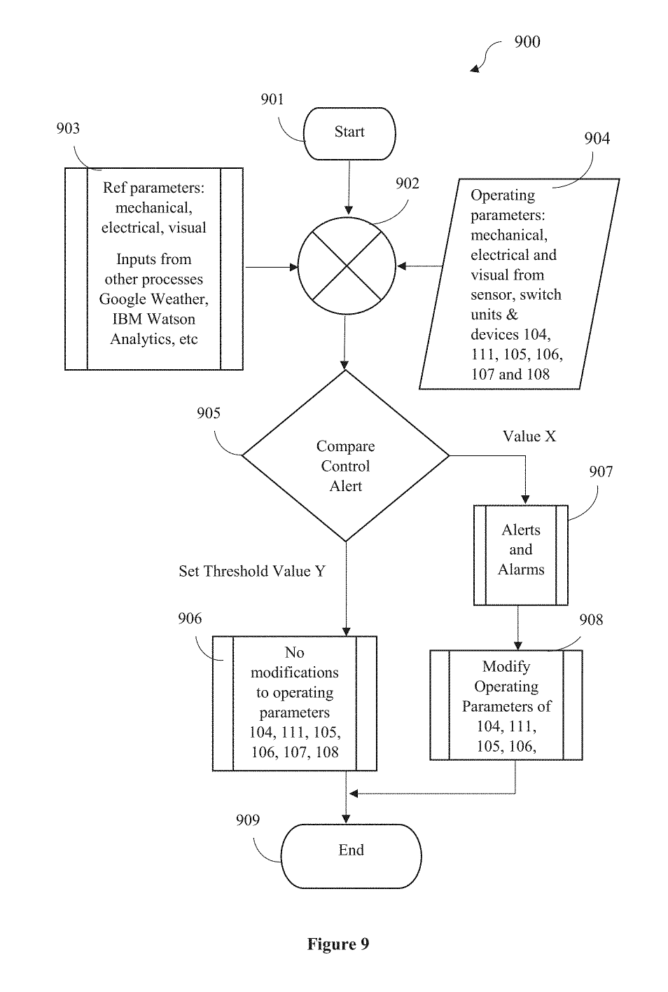

Basically, the system 100 may enable working on an TOT (Internet of Things) platform. The system 100 may be configured to provide energy saving, asset management, consumer behavior and equipment as Service. The system 100 is cost efficient as savings pays back the investment in less than 15 months and multiple devices, equipment and systems 100 may be managed over central computer implemented platform efficiently. In one embodiment, all the sensors in the sensor unit 104 and/or switch unit 111 may be configured to provide inputs to the primary server 103, depending on which the primary server 103 may initiate set points. The set points may be initiated depending on the instructions decided by the central server 101. The system 100 is easy to install, less complex, and less time consuming. The durability of the system 100 is also increased due to its asset management capabilities on its hardware, firmware and software. The system 100 may be configured to be used in various infrastructures such as offices, houses, hotels, commercial establishments, industries, vehicles and like infrastructures. The infrastructures may not be limited to said infrastructures. The sensors in the sensor unit 104 and/or switch unit 111 may not be limited to said sensors. In one embodiment, the working of system 100 is flexible and fast due to the distributed intelligence and decision making at primary server 103, sensor unit 104 and/or switch unit 111, selection of instructions based on the infrastructure scenario and surrounding weather conditions and customizing set points in accordance with the instructions. The load on the server is reduced as the due to distributed intelligence architecture of system 100. Referring to FIG. 9, an overall method 900 for controlling and monitoring the devices for the purpose of asset management in an infrastructure is illustrated in accordance with the present subject matter.

At step 901, the process may begin at primary server 103 or central server 101. At step 904, one or more inputs from sensor unit 104, switch unit 111 and devices 105, 106, 107, 108 may be received via processor 209. In one embodiment, the sensor unit 104 and/or switch unit 111 may sense various inputs and parameters such as mechanical, electrical and visual from operating devices 105, 106, 107 and 108 in an infrastructure. The sensed inputs may be processed, transmitted via network connectivity 102 or 109 and further processed by the computer implemented platform via processor 209.

At step 903, reference performance parameters such as mechanical, electrical and visual of devices 105, 106, 107, 108 and inputs from third-party processes such as but not limited to, Google Weather or IBM Watson Analytics pertaining to optimum operations of 105, 106, 107, 108 may be run via processor 209, to determine the optimum setpoints for devices in 105, 106, 107, 108.

At process 902, inputs from 903 and 904 may be consolidated or processed and fed via processor 209, to a decision-making step at 905.

At step 905, a comparison may be performed via processor 209, with a set threshold value, wherein said threshold value may be set via processor 209 depending on the processing performed at step 902. If the operating parameters from 904 and the reference parameters from 903 may be within a set threshold value Y, system 100 may continue working with operating parameters of step 904 at step 906. If the comparison at step 905 may not be within the limits of the set threshold value Y, then an alert may be generated at 907. The alert may be sent to primary server 103 and central server 101. Operating parameters from 904 may be adjusted at step 908 and communicated to the sensor unit 104, switch unit 111, devices 105, 106, 107, 108. The process ends at step 909. All the steps in process 900 may be performed via processor 209, wherein the processor 209 may be comprised in primary server 103.

The system 100 may be designed to raise alerts due to network failures, device failures, sensor or switch failure. This is just an indicative list and more alerts are being added.

System 100 may be designed to raise alerts on to events like temperature breach compared to set temperature, energy consumption benchmark breach compared to set benchmark, next servicing due based on run hours. This is just an indicative list and more alerts are being added.

Alerts serve the purpose of administration from exception handling meaning the attention is drawn to the raised alerts rather than to look for abnormality in the systems that is spread across large geographic area.

The system 100 is architected to be alerts driven. Alerts are raised by the primary server 103 or central server 101.

Primary server 103 raises alerts on disconnection of sensor unit 104/switch unit 111 or devices 105, 106, 107, 108 connected to sensor/switch unit. Primary server 103 raises alerts also on events like temperature breach, energy consumption benchmark breach. All the alerts raised at primary server are propagated to central server. Central server 101 does the notification of alerts to the stakeholder over email, sms, etc.

Central server raises alerts on connection failure between the primary server and secondary server and raises notifications to the stakeholders over email and sms.

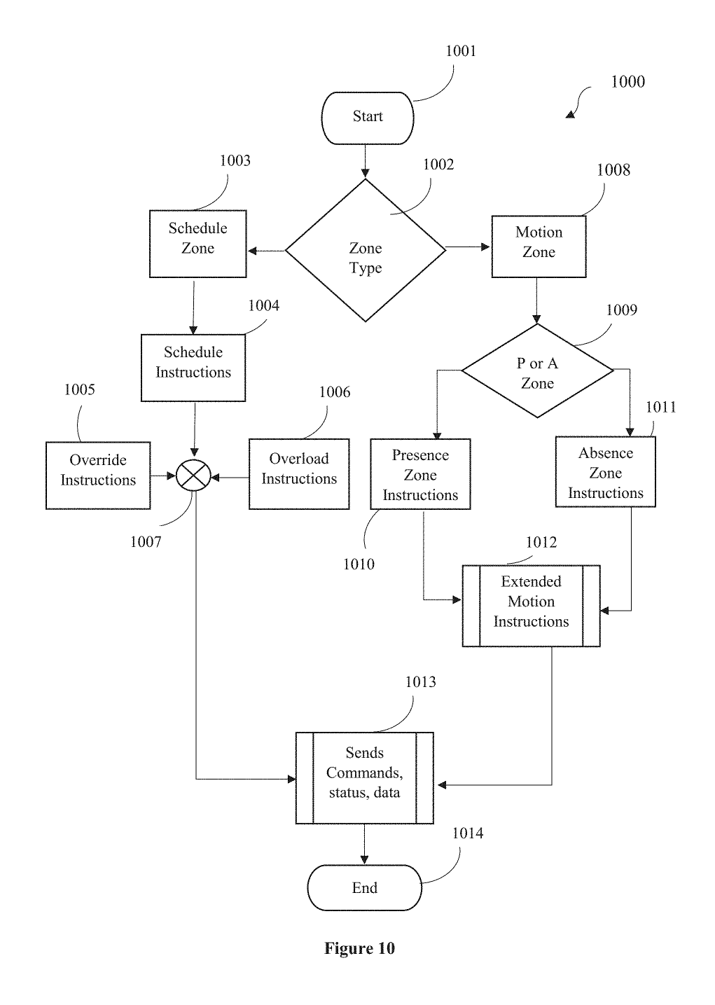

Referring to FIG. 10, an overall method 1000 for controlling and monitoring operating parameters of the devices in an infrastructure for the purpose of energy saving is illustrated in accordance with the present subject matter.

At step 1001, the process begins at primary server 103 or central server 101 via processor 209. At step 1002, zone type information may be provided via processor 209 to the schedule instructions 600. Zone type may be Schedule Zone 1003. In such situation Schedule Zone instructions 600 may be activated at step 1004. Schedule command as per the schedule may be calculated by the instructions and sent to one or more sensor unit 104, switch unit 111 and devices 105, 106, 107, 108.

In one embodiment, before final schedule command is calculated, overload instructions 800 may be activated at step 1006 and the schedule command may be accordingly modified. Such revised Schedule command as per the schedule and overload instructions 800 may be sent to one or more sensor unit 104, switch unit 111 and devices 105, 106, 107, 108.

At step 1005, override instructions 606 may be activated via processor 209. Override instructions may override the schedule and overload command. Override instructions are necessary for switching on-off of devices 105, 106, 107, 108 that may be out of schedule for the purpose maintenance and overtime work requirement in a selected zone.

At step 1007, the inputs from steps 1006 and 1005 may be processed and passed to step 1013.

At step 1013, a final command may be sent via processor 209 to one or more sensor unit 104, switch unit 111 and devices 105, 106, 107, 108. The processor 209, at step 1013 also receive via network 109, the sensor status, device status, time stamp and like parameters.

In one embodiment, at step 1013, the central server 101, at step 1013 may also receive via network 102 and 109, the sensor status, device status, time stamp and like parameters.

At step 1002, if the zone type may be selected as Motion Zones, then the motion zone instructions 700 may be run at step 1008. Motion Zone may be further classified as Presence Zone or Absence Zone at step 1009.

For embodiment where the motion zone may be classified as Presence Zone, presence instructions from the instructions 700 may be activated at step 1010. For another embodiment, where Motion zone may be classified as Absence Zone, absence instructions 700 may be activated at step 1011. If the identified and classified motion continues beyond predefined time, extended motion instructions of step 707 from the instructions 700 may be applied at step 1012.

At step 1013, a final command may be sent via processor 209 to one or more sensor unit 104, switch unit 111 and devices 105, 106, 107, 108. The processor 209, at step 1013 also receive via network 109, the sensor status, device status, time stamp and like parameters.

In one embodiment, at step 1013, the central server 101, at step 1013 may also receive via network 102 and 109, the sensor status, device status, time stamp and like parameters.

In one embodiment, at step 1013, the commands, ambient parameters, operating statues may be sent via processor 209 to the sensor unit 104, switch unit 111, devices 105, 106, 107 and 108. Further, the consolidated data may also be sent via processor 209 on network 102 and 109 to the central server 101.

At step 1014, the process 1000 may end.

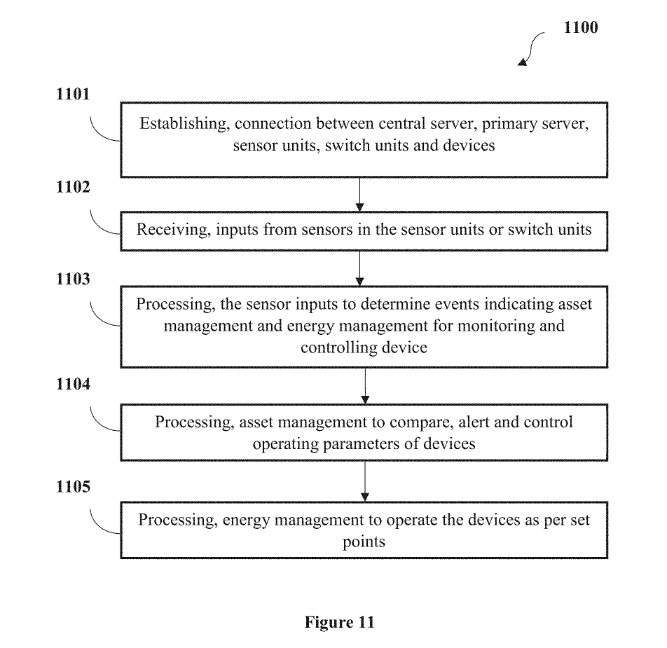

Referring to FIG. 11, a method 1100 for monitoring and controlling devices and processes in an infrastructure is illustrated in accordance with the present subject matter. At step 1101, a connection may be established in the system 100. In one embodiment, establishing, via a network connectivity 102, 109 one or more connections between central server 101, primary server 103, sensor units 104, switch units 111 and devices 105, 106, 107 and 108 may be performed.

At step 1102, inputs from the sensors may be received. In one embodiment, receiving, via a processor 209 inputs from sensors in the sensor units 104 or switch units 111 may be performed. The sensors in the sensor units 104 or switch unit 111 are configured to continuously sense the ambient and operating parameters of the devices 105, 106, 107 and 108 and one or more predefined parameters in the infrastructure.

At step 1103, processing of sensor inputs may be done. In one embodiment, processing, via the processor 209 one or more sensor inputs to determine one or more events indicating asset management and energy management for monitoring and controlling the devices 105, 106, 107 and 108 may be performed.

At step 1104, processing for asset management may be done. In one embodiment, processing, via the processor 209 asset management in the infrastructure to compare, alert and control operating parameters of devices as per one or more set points may be performed may be performed.

At step 1105 processing of energy management may be done. In one embodiment, processing, via the processor 209 energy management in the infrastructure to operate the devices 105, 106, 107 and 108 as per one or more set points may be performed.

Although implementations of a system and method for monitoring and controlling devices in an infrastructure have been described in language specific to structural features and/or methods, it is to be understood that the appended claims are not necessarily limited to the specific features or methods described. Rather, the specific features are disclosed as examples of a system and method for monitoring and controlling devices in an infrastructure.

What is claimed is:

1. A system for monitoring and controlling devices and processes in an infrastructure, comprising:
one or more devices in an infrastructure are configured to operate in multiple zones, wherein said devices are continuously monitored and controlled based upon one or more set points;
one or more sensor units and switch units comprising one or more sensors, wherein the one or more sensors have a network connectivity with said devices and a primary server or a central server; and
one or more primary servers configured to communicatively coupled with a central server, wherein a processor in each primary server is configured to execute programmed instructions stored in a memory coupled with each primary server for controlling and monitoring the devices and the sensor units or the switch units, wherein the programmed instructions comprises instructions for:
receiving, one or more inputs from the sensors in the sensor units or switch unit or devices, wherein the sensors in the sensor units or switch unit or devices are configured to continuously sense the ambient and operating parameters of the devices and one or more predefined parameters in the infrastructure; and
processing, the one or more sensor inputs to determine one or more events indicative of monitoring and controlling the devices, wherein the indicative events comprises:
asset management in the infrastructure, wherein asset management is configured to compare, alert and control the operating parameters of the devices as per the one or more set points and one or more predefined parameters in the infrastructure; and
energy management in the infrastructure, wherein energy management is configured to operate the devices as per the one or more set points and zones.

2. The system of claim 1, wherein the asset management in the infrastructure comprises:
receiving, via the processor, one or more inputs from sensor unit, switch unit and devices;
receiving, via the processor, reference performance parameters from third-party processes to determine the setpoints for devices;
processing, via the processor, the inputs and the reference performance parameters to consolidate and make a decision to compare, control and alert about the operating parameters of the devices with a set threshold value;
operating, via the processor, the devices based on said operating parameters if the operating parameters are within the set threshold value;
alerting, via the processor, the primary server and central server if the operating parameters or one or more predefined parameters in the infrastructure are not within the limits of the set threshold value; and
adjusting, via a processor, the operating parameters and communicating said parameters to the sensor unit, switch unit, devices via network connectivity.

3. The system of claim 1, wherein the energy management in the infrastructure comprises:
identifying, the zone type of the infrastructure, wherein the zone type comprises schedule zone and motion zone;
communicating commands, statuses and data to and from the sensor unit, switch unit, devices with the primary server or central server via network connectivity;
alerting, via the processor, the primary server and central server if the energy consumption and quality parameters in the infrastructure are not within the limits of the set threshold value; and
adjusting, via a processor, the operating parameters and communicating said parameters to the sensor unit, switch unit, devices via network connectivity to achieve energy efficiency.

4. The system of claim 1, wherein the sensor unit and the switch unit comprise:
lux sensor, temperature and humidity sensor, head count sensor, air quality sensor, motion sensor, Infrared transmitter, camera, Wired or Wireless connectivity module, extended goose neck conduit for sensor mounting enabling maximum network coverage and most appropriate transmit angle for directional wireless technologies; and
override button for out of schedule operations and to command and control devices wherein:
the devices comprise powered devices such as refrigerators, deep refrigerators, walking refrigerators, ovens, coffee machines, geysers;
the devices comprise HVAC devices such as HVAC appliances, duct able controllers;
the devices comprise lighting devices such as lighting appliances, LED drivers, street lighting; and
the devices comprise third-party devices such as energy meter, UPS, battery, solar panel, Gen Set, air quality equipment, elevators, escalators.

5. The system of claim 1, wherein the infrastructure comprises offices, companies, industries, warehouses, other commercial buildings, houses, vehicles, public places like gardens, grounds, streets, auditoriums, cinema halls and wherein the network connectivity and an internet network comprise wired network, wireless network, LAN, WAN, VPN, GPRS, cellular networks.

6. The system of claim 1, wherein the primary server is an appliance with standard and custom developed hardware, network interfaces, embedded with an operating system and custom developed software and firmware implemented platform, wherein the primary server continues to command and control the system in the event of network connectivity failure causing disconnectivity with the central server.

7. The system of claim 6, wherein after restoration of the network connectivity, an accumulated data processed during network connectivity failure by the primary server to control and command the system is uploaded to the central server and further any new global policies generated during network connectivity failure are downloaded from the central server.

8. The system of claim 3, wherein the processor, configured to execute the motion zone instructions comprises:
defining, a motion zone with motion parameters, wherein on motion parameters are predefined;
operating, the desired motion zone, wherein the motion zone comprises an absence zone and presence zone;
operating, the absence zone wherein no action is taken by the system and user is given the choice to activate the devices according to the set points of choice, and wherein the devices are switched off by system on detection of absence of people in order to avoid false triggering of devices due to unintended motion or presence; and
operating, the presence zone based on the predefined set points of the said zone, wherein presence zone is operative on detecting presence zone conditions and devices are turned on and controlled according to one or more set point commands initiated; and
detecting, an extended motion, wherein a set of dynamic instructions are executed on said detection, wherein extended motion comprises detecting desired motion in the infrastructure after a predefined On time On Motion.

9. The system of claim 4, wherein the sensor unit and switch unit comprise a memory module to manage the memory used for firmware update through OnTheAir or OnTheWire mechanism, wherein the said mechanism allows the sensor unit to receive any update to the firmware from the primary server or central server over network connectivity without disruption to the sensor unit's running operations.

10. The system of claim 4, wherein the sensor unit and the switch unit comprise an override button to switch devices out of schedules, wherein the override button enables the user through sensor unit or switch unit to switch devices ON or OFF or alter set point out of schedule wherein such out of schedule overrides are also reported to primary server or central server over network connectivity.

11. The system of claim 4, wherein sensor unit and switch unit comprise of sensors and mechanism to command and control devices and sends schedule commands received from primary server or central server to devices at predefined time period in order to bring the devices back to the schedule even if deviation is caused in the desired set points for operating the devices.

12. The system of claim 2, wherein the devices are prevented from being overloaded than their maximum or minimum limits by execution of overload preventive instructions via processor, wherein said overload preventive instructions comprise:
initiating, a set point command to the sensor unit or switch unit for setting set points;
receiving, inputs from sensors in the sensor unit or switch unit;
comparing this received sensor input with the value of the set points after a predefined time; and
setting, one or more new set points if the value of the set points is less or more than the threshold limits of sensor inputs after the predefined time.

13. The system of claim 4, wherein the sensor unit and switch unit comprise motion detector for reporting motion and energy use out of schedule wherein such out of schedule motion and energy use are also reported to primary server or central server over network connectivity.

14. The system of claim 4, wherein sensor unit and switch unit comprises of air quality sensors, temperature and humidity sensor and relays, wherein on predefined threshold breach, the system activates relays to open or close fresh air duct of HVAC system for the purpose of air side economizer or demand controlled ventilation functions and wherein all such threshold breaches are reported to primary server or central server over network connectivity.

15. The system of claim 4, wherein sensor unit and switch unit comprise of sensors to measure electrical, mechanical and visual profiles of devices in order to transmit said sensor data over network connectivity to primary server or central server 101 wherein the primary server or central server compares the sensor data with ideal electrical, mechanical and visual profiles of devices and decides on preventive or prescriptive maintenance alerts.

16. The system of claim 1, wherein third party devices, sensors and actuators with standard communication port communicate directly with primary server or central server over network connectivity enabling functions of asset management and energy management.

17. The system of claim 1, wherein the system comprises a headcount and people movement heat map in the infrastructure, wherein said headcount and people movement heat map is configured by tracking WiFi unit on the mobile phone. Mobile phone identity is configured to link social media profiling of the people in the infrastructure.

18. The system of claim 1, wherein the system comprises a product as service in the infrastructure, wherein operating hours and parameters of devices are consolidated for fair distribution of Energy Expense per usage of consolidated capacities.

19. The system of claim 1, wherein the system is configured to raise alerts due to network failures, device failures, sensor unit or switch unit failure, wherein said alerts are raised by the primary server or central server.

20. A method for monitoring and controlling devices and processes in an infrastructure comprising:
establishing, via a network connectivity one or more connections between a central server, a primary server, sensor units, switch units and a plurality of devices;
receiving, via a processor inputs from sensors in the sensor units or switch units, wherein the sensors in the sensor units or switch unit are configured to continuously sense the ambient and operating parameters of the devices and one or more predefined parameters in the infrastructure, wherein the predefined parameters comprise one or more set point and multiple zones;
processing, via the processor one or more sensor inputs to determine one or more events indicating asset management and energy management for monitoring and controlling the devices;
processing, via the processor asset management in the infrastructure to compare, alert and control operating parameters of devices as per one or more set points and zones; and
processing, via the processor energy management in the infrastructure to operate the devices as per one or more set points and zones.
